(19) United States
(12) Patent Application Publication
(10) Pub. No.: US 2008/0021620 A1
(43) Pub. Date: Jan. 24, 2008

(54) Control of Driveline Geometry

(75) Inventors: Inge Johansson, Molnlycke (SE); John Henstrom, Alingsas (SE); Stefan Edlund, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/720,210

(22) PCT Filed: Dec. 8, 2005
(86) PCT No.: PCT/SE05/01862

§ 371 Date: May 25, 2007

(30) Foreign Application Priority Data
Dec. 20, 2004 (SE) 0403156-3

(51) Int. Cl. B60K 17/24; G06F 19/00

(52) U.S. Cl. 701/49; 180/379

(57) ABSTRACT

A system for control of driveline geometry of a heavy vehicle includes a propeller shaft that is suspended in a center bearing unit, the position of which center bearing unit can be adjusted, wherein the adjustment is determined based on one or more measurements of one or more geometrical parameters of the vehicle and the chassis acceleration. A method for control of such a propeller shaft geometry and a heavy vehicle comprising such a system and/or by use of such a method are also disclosed.

The present invention relates to control of the driveline geometry in heavy vehicles, and in particular to an continuous adjustment of a centre bearing unit, in which a propeller shaft is suspended, to give an optimal geometry during driving of the vehicle.

### BACKGROUND OF THE INVENTION

The engine and transmission of a heavy vehicle are connected to a rear axle by a shaft, often referred to as a cardan shaft or more common as a propeller shaft, for transmission of a rotational moment to the rear axle. The propeller shaft has universal joints at the ends to compensate for the propeller shaft angles. The propeller shaft angles vary, e.g. when the vehicle is loaded, which may result in unbalances in the system whereby the ends of the propeller shaft rotationally accelerate and decelerate at different rates. The resulting vibrations lead to noise, increased wear, and discomfort for the driver. It is well known in the art to compensate for these unbalances e.g. by use of an air-ride suspension system. Such systems are known in which the rotational acceleration of the propeller shaft of a vehicle is monitored and used to adjust the propeller shaft angles by inflating or deflating the springs of the air-ride suspension system. Hereby the engine/transmission and the rear axle are displaced relative to a chassis part of the vehicle, and the propeller shaft angles are thereby adjusted. Another system is known for alignment of the propeller shaft of a vehicle in which the compensation is carried out by use of a hydraulic actuator. The hydraulic actuator is located on the frame of the vehicle to pull a bracket supporting a centre bearing. In this system, the droops of the axles are detected by use of laser sensors.

### DESCRIPTION OF THE INVENTION

An object of the present invention is to provide control of the propeller shaft geometry to minimise variations in the torque and force, and thereby the resulting vibrations of the propeller shaft. This will both increase the durability of the propeller shaft components and improve the driver's working environment, which may be obtained in all loading conditions for the propeller shaft and for different chassis height adjustments. It also enables that the dispersion of the installation from the factory can be adjusted to the optimal position.

The present invention relates in a first aspect to a system for control of driveline geometry of a heavy vehicle, wherein the propeller shaft is suspended in a centre bearing unit the position of which can be adjusted, characterised in that the adjustment is determined based on one or more measurements of one or more geometrical parameters of the vehicle and the chassis acceleration.

In most preferred embodiments of the present invention, only the height of the centre bearing is adjusted and adjustable, but in the broadest scope of the invention also the horizontal position of the centre bearing is adjusted and adjustable.

Furthermore, the system and the method according to the present invention are preferably implemented so as to operate automatically, e.g. without the need for an operator to intervene. However, the system and the method may of course implement an option of more or less operator control.

The chassis acceleration is determined by at least one accelerometer placed on the chassis. The rear chassis height will depend both on dispersions in vehicle components and its installations and on the actual loading of the vehicle. In a preferred embodiment of the invention, the position of the centre bearing unit may therefore be pre-adjusted according to the actual rear chassis height and fine-tuned based on the chassis acceleration which will vary during driving.

The rear chassis height or the inclination between the propeller shaft and the chassis may change due to e.g. braking or acceleration of the vehicle. It may be desired not always to compensate for these changes in order to avoid unnecessary adjustments related to these short-term unbalances in the system. In a preferred embodiment of the invention this may be accomplished by ensuring that the adjustments of the position of the centre bearing unit do not take place until the torsional moment on the propeller shaft exceeds a pre-defined value for more than a pre-defined period of time.

The control of the driveline geometry may be determined in an electronic control unit. The performance of the system may be improved by letting the electronic control unit comprise filters for removal of certain pre-defined frequencies, such as those characteristic for the propeller shaft, as a step in the calculations of the desired centre bearing position. It may also be possible to remove vibrations below a pre-defined amplitude, since these will often be due to the driving taking place on an uneven surface, i.e. vibrations that cannot be avoided.

The movement of the centre bearing unit is preferably driven by at least one electric motor. In a preferred embodiment of the invention, the position of the centre bearing unit can be adjusted in one direction which may preferably be vertically but which may also be horizontally. In another preferred embodiment, the position of the centre bearing unit may be adjusted both vertically and horizontally. When the position can be adjusted both vertically and horizontally, the movements may be driven by one or two motors.

The adjustment of the centre bearing unit may be accomplished by a system in which the centre bearing unit can be moved along at least two threaded bolts while being supported by guides that move linearly within a frame, said bolts being rotated by an electric motor.

Another possibility is to use a system in which the centre bearing unit is mounted to interdependent jaw-tongs mechanisms for linear movement in one or both directions.

In the system where the centre bearing unit moves along threaded bolts, the electric motor rotation, Vz, rotates these threaded bolts mounted in the frame whereby the centre bearing unit is moved. In the system with jaw-tongs mechanisms the electric motor rotates the central threaded bolts.

The present invention relates in another aspect to a method for control of driveline geometry of a heavy vehicle, wherein the propeller shaft is suspended in a centre bearing unit the position of which can be adjusted, characterised in said method comprising the steps of: measuring one or more geometrical parameters of the vehicle and measuring the chassis acceleration, determining an optimal position of the centre bearing unit based on the measured parameters, and adjusting the position of the centre bearing unit to the determined optimal position.

As described above, it may be desired to avoid unnecessary adjustments related to short-term unbalances in the system. This may e.g. be accomplished by letting the method further comprise the steps of: measuring of the torsional moment on the propeller shaft, comparing the measured torsional moment to a pre-defined value, measuring the period of time in which the measured torsional moment exceeds the pre-defined value, and omitting adjustment of the position of the centre bearing unit until the measured torsional moment exceeds said pre-defined value for a longer period of time than a pre-defined value.

As mentioned, the method may be improved by letting it further comprise the steps of removing certain pre-defined frequencies, such as those characteristic of the rotational speed of the propeller shaft, from the measured acceleration signals before the determination of the optimal position of the centre bearing unit. The rotational speed of the propeller shaft can be obtained either by combining the speed of the vehicle with the known rear axle ratio or by combining the engine rotational speed with the selected gear. Hereby it may be possible to obtain faster and/or more precise calculation of the optimal position. It may also be possible to remove vibrations below a pre-defined amplitude, since these will often be due to the driving taking place on an uneven surface, i.e. vibrations that cannot be avoided.

In both systems described for movement of the centre bearing unit, the electric motor rotation, Vz, which rotates either the threaded bolts or threaded central rods of the jaw-tongs mechanisms, may preferably be determined from an electronic control unit function of the following type:
Vz=f(H,a)+g(chassis acceleration)
where: Vz is the electric motor rotation
H is the rear chassis height
a is the centre bearing position

In a preferred embodiment, the position of the centre bearing unit is pre-adjusted according to the rear chassis height and fine-tuned during driving based on the chassis acceleration. The function f may preferably be defined by the type of rear axle installation, whereas the function g may preferably be equal for all vehicle variants.

In a preferred embodiment of the invention, the optimal position of the centre bearing unit is determined from stored information on correlation between a given frequency spectrum and an optimal position of the centre bearing unit. This information may be stored in a look-up table having either pre-defined information or being continuously up-dated with new information on said correlations. It may also be possible to let the electronic control unit comprise means being trained to recognise specific patterns in the chassis accelerations while paying attention to the rear chassis height and the centre bearing position. Such a trained system preferably comprises a neural network based computer system trained for instance by a reward/punishment method.

In addition to the advantages of improved working conditions for the driver and optimal durability for driveline components as mentioned above, the present invention has further advantages. The possibility of adjusting the position of the centre bearing unit during use of the vehicle results in less administration of centre bearing brackets and positions both in the design process and in the production. The customers achieve the advantages that more specifications are available due to fewer restrictions and that less after-market service actions are needed due to the lower wear of the components.

A third aspect of the invention relates to a heavy vehicle comprising a system for control of driveline geometry of a propeller shaft of the vehicle according to the description given above.

A fourth aspect of the invention relates to a heavy vehicle comprising a system for control of driveline geometry of a propeller shaft of the vehicle, wherein the propeller shaft is suspended in a centre bearing unit the position of which can be adjusted, and wherein the adjustment is determined by a method as described above.

### BRIEF DESCRIPTION OF THE FIGURES

In the following, preferred embodiments of the present invention will be disclosed in details in connection with the accompanying figures in which:

FIG. 1 shows schematically parameters that may be taken into account in the control of the driveline geometry,

FIG. 2 shows a preferred embodiment of the system for vertical adjustment of the centre bearing unit and thereby the propeller shaft,

FIG. 3 shows another preferred embodiment of the system for vertical adjustment of the centre bearing unit, and

FIG. 4 shows a preferred embodiment of the invention in which the position of the centre bearing unit can be adjusted both vertically and horizontally.

### DETAILED DESCRIPTION OF THE FIGURES

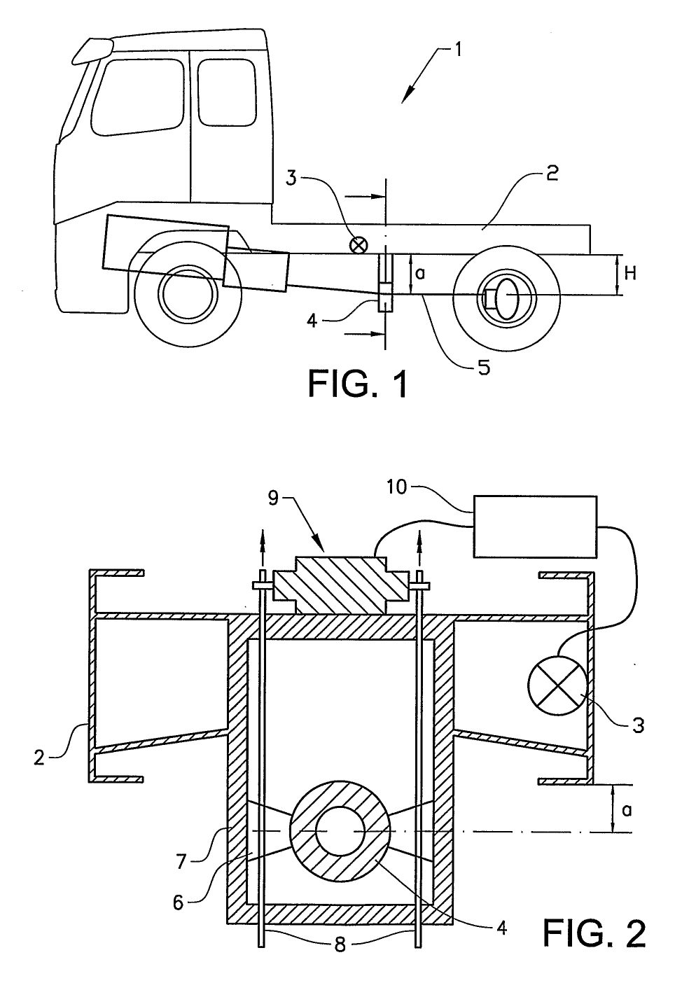

The present invention will now be described in further details with reference to the figures. FIG. 1 shows schematically a heavy vehicle 1 having a chassis 2 on which an accelerometer 3 is mounted. The rear chassis height, H, and the centre bearing position, a, of the centre bearing unit 4 are indicated. The rear chassis height H is measured as the distance between a selected position on the rear axle and the underside of the chassis. This value is usually used to indicate the chassis height on vehicles with air suspension. Thus, if the vehicle is equipped with an air suspension, a value representing H Is already present to the control system. This signal is normally measured with a potentiometer, but can of course be measured by any other means.

The centre bearing position, a, is the distance between a position of the centre bearing, e.g. the centre of the bearing, and the underside of the chassis. The distance a is adjusted in order to minimise the vibrations of the propeller shaft. The distance a may be measured by any appropriate means or may be derived from the revolutions of the electric motor 9, see FIG. 2.

FIG. 2 shows schematically one preferred embodiment of the invention in which the centre bearing position can be adjusted vertically. The centre bearing unit 4 for suspending the propeller shaft (not shown in this figure) is mounted on guides 6 that can move linearly within a frame 7 mounted to the chassis 2 of the vehicle 1. The guides 6 comprise internal threads in rotational mesh with threaded bolts 8 mounted in bearings (not shown) inside the frame 7. An electric motor 9 rotates the bolts 8 whereby the height of the centre bearing unit 4 is changed. The rotation, Vz, of the electric motor 9 is controlled by an electronic control unit 10. The electronic control unit 10 may preferably be placed adjacent to the motor 9, but it may in principle be placed anywhere on the vehicle 1, such as in the driver's cab. The input parameters for the electronic control unit 10 are the chassis acceleration measured by an accelerometer 3 mounted to the chassis 2, the rear chassis height, H, and the actual centre bearing position, a.

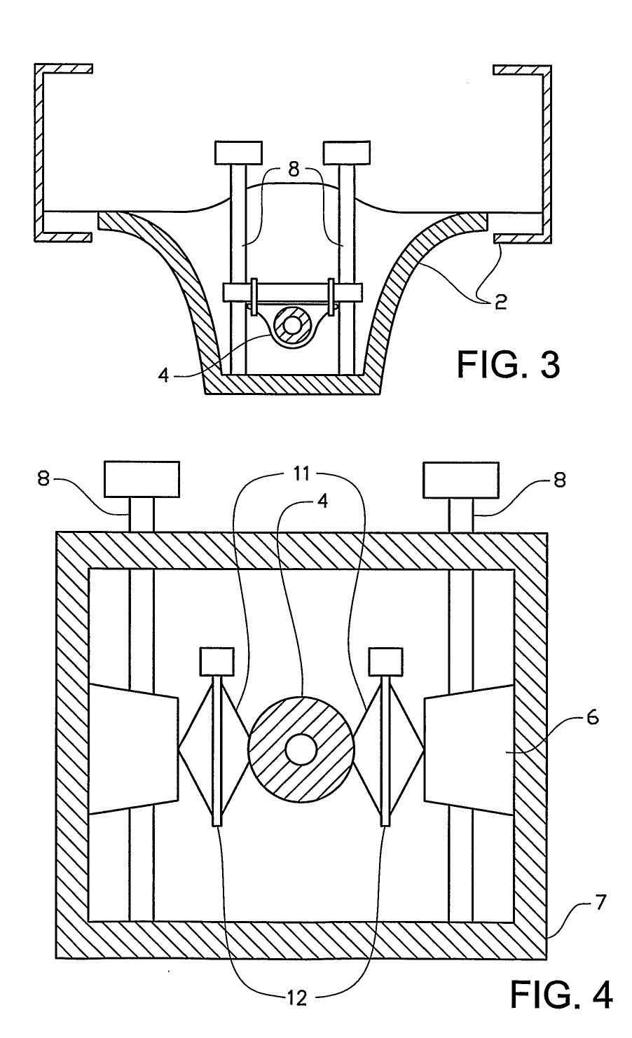

FIG. 3 shows another preferred embodiment of the system for vertical adjustment of the centre bearing unit 4 along threaded bolts 8. In this embodiment the bolts 8 are mounted in bearings (not shown) in a specially designed part of the chassis 2. The movement of the centre bearing unit 4 is only supported by the bolts 8 which may therefore need to be stiffer to provide enough stability.

FIG. 4 shows schematically another preferred embodiment of the invention in which the position of the centre bearing unit 4 can be adjusted both vertically and horizontally. The vertical movement is carried out in the same way as for the system shown in FIG. 1. The horizontal movement is done by means of two jaw-tongs mechanisms 11 each having the same working principle as a screw jack used to lift a car e.g. to replace a wheel. The embodiment shown has two such jaw-tongs mechanisms 11 in order to ensure a high stability. However, it is possible to use only one mechanism preferably in combination with other means for guiding the movement. When two jaw-tongs mechanisms 11 are used, horizontal movement takes place when one mechanism is contracted while the other is extended synchronously. The two mechanisms may preferably be driven by one motor (not shown) which may be the same as the one used for the vertical movement. The rotation of the central rods 12 of the jaw-tongs mechanisms 11 may be synchronised e.g. by meshing gears or by means of a belt (not shown).

The maximum vertical and horizontal movement of the centre bearing unit may vary dependent on the specific design of the control system, but they will typically be up to 140 mm and up to 40 mm, respectively. More specifically, when a pre-adjustment is done during assembly of the vehicle, a movement of 50 mm and 20 mm, respectively, is sufficient.

It may be understood that even though the figures only disclose systems in which the vertical movement of the centre bearing unit 4 is carried out by means of threaded bolts 8, and the horizontal movement is shown as carried out by means of jaw-tongs mechanisms 11, other combinations, such as the use of jaw-tongs mechanisms 11 for both vertical and horizontal movement, are included in the teaching of the invention.

In a preferred embodiment of the invention, the position of the centre bearing unit can be pre-adjusted according to the rear chassis height and fine-tuned during driving based on the chassis acceleration. The optimal position of the centre bearing may be determined from stored information on correlations between given frequency spectra and optimal positions of the centre bearing unit. This information may e.g. be stored in a look-up table comprising characteristic parameters, such as the most dominant frequencies and their corresponding amplitudes. Each adjustment of the centre bearing position may give rise to a change in the frequency spectrum, and the adjustment is therefore an iterative process. This may e.g. be implemented by letting the method used in the electronic control unit comprise the following steps: based on the detected chassis acceleration (optionally being filtered), the present height of the centre bearing and rear chassis height, the entry in the look-up table being closest to this set of parameters is selected. The corresponding stored correction of the bearing centre position is retrieved and the centre bearing position is adjusted accordingly. This process may be continued a number of times until the chassis acceleration is within a pre-selected range. If this procedure results in a new set of corresponding parameter values for chassis height, centre bearing position, chassis acceleration and correction of the centre bearing position made, these values are stored in the look-up table.

In a further embodiment of the invention, the adjustment of the centre bearing position is improved by removing certain pre-defined frequencies, such as those characteristic of the rotational speed of the propeller shaft, from the measured acceleration signals before the adjustment of the position of the centre bearing unit. The rotational speed of the propeller shaft Is obtained by combining the measured speed of the vehicle with the known rear axle ratio. Another way of obtaining the rotational speed of the propeller shaft is to combine the engine rotational speed with the selected gear. Hereby it is possible to obtain faster and/or more precise calculation of the optimal position. It is also possible to remove vibrations below a pre-defined amplitude, since these will often be due to the driving taking place on an uneven surface, i.e. vibrations that cannot be avoided.

It may be a further possibility of the invention to include the use of GPS in the system. Hereby information on the surroundings may be implemented and taken into account in the control of the centre bearing position. It may e.g. be possible to pre-adjust the position of the centre bearing position according to knowledge about steep hills, sharp corners or the like.

1. A system for control of driveline geometry of a heavy vehicle, the vehicle comprising a chassis the system, comprising a propeller shaft and a center bearing unit in which the propeller shaft is suspended, a position of being adapted to be adjusted by an adjustment in response to one or more measurements of one or more geometrical parameters of the vehicle and chassis acceleration.

2. A system according to claim 1, wherein the chassis acceleration is determined by at least one accelerometer placed on the chassis.

3. A system according to claim 1, wherein the position of the center bearing unit is pre-adjusted according to a rear chassis height and fine-tuned based on the chassis acceleration.

4. A system according to claim 1, wherein a determination of adjustment comprises measuring torsional moment on the propeller shaft, and wherein adjustments of the center bearing unit do not take place until the torsional moment on the propeller shaft exceeds a pre-defined value for more than a pre-defined period of time.

5. A system according to claim 1, comprising a control unit adapted to determine the adjustment.

6. A system according to claim 5, wherein the control unit comprises filters for removal of certain pre-defined frequencies.

7. A system according to claim 5, wherein the control unit comprises means trained to recognise specific patterns in chassis accelerations while paying attention to a rear chassis height and the center bearing position.

8. A system according to claim 1, wherein the center bearing unit is moved by at least one electric motor.

9. A system according to claim 1, wherein center bearing unit is adjusted by being moved along at least two threaded bolts while being supported by guides (6) that move linearly within a frame, the bolts being rotated by an electric motor.

10. A system according to claim 1, wherein the center bearing unit is mounted to interdependent jaw-tongs mechanisms for linear movement in at least one direction.

11. A system according to claim 1, wherein the position of the center bearing unit is adapted to be adjusted at least one of vertically and horizontally.

12. A system according to claim 1, wherein the center bearing unit is moved in two directions by at least one electric motor.

13. A system according to claim 12, wherein the center bearing unit is moved by use of jaw-tongs mechanisms in at least one direction.

14. A system according to claim 1, wherein the system operates automatically.

15. A method for control of driveline geometry of a heavy vehicle having a chassis, wherein a propeller shaft is suspended in a center bearing unit the position of which center bearing unit can be adjusted, the method comprising:
measuring one or more geometrical parameters of the vehicle;
measuring the chassis acceleration;
determining an optimal position of the center bearing unit based on the measured parameters; and
adjusting a position of the center bearing unit to the determined optimal position.

16. A method according to claim 15, comprising:
measuring torsional moment on the propeller shaft;
comparing the measured torsional moment to a pre-defined value;
measuring a period of time in which the measured torsional moment exceeds the pre-defined value; and
omitting adjustment of the position of the center bearing unit until the measured torsional moment exceeds the pre-defined value for a longer period of time than a pre-defined value.

17. A method according to claim 15, comprising the steps of filtering out certain pre-defined frequencies, from the measured acceleration before determination of the optimal position of the center bearing unit.

18. A method according to claim 15, wherein the motor rotation resulting in the determined optimal position of the center bearing unit is determined by use of a function of the following type:
Vz=f(H,a)+g(chassis acceleration)
where: Vz is the electric motor rotation
H is the rear chassis height
a is the center bearing position.

19. A method according to claim 18, wherein the position of the center bearing unit is pre-adjusted according to a rear chassis height and fine-tuned based on the chassis acceleration.

20. A method according to claim 18, wherein a function of the rear chassis height and the center bearing position is defined by a type of rear axle installation.

21. A method according to claim 18, wherein a function of the chassis acceleration is equal for all vehicle variants.

22. A method according to claim 15, further comprising:
determining the optimal position of the center bearing unit from stored information on correlation between a given frequency spectrum and an optimal position of the center bearing unit.

23. A method according to claim 22, wherein the information is stored in a look-up table having at least one of pre-defined information and information continuously up-dated with new information on the correlation.

24. A heavy vehicle comprising a system according to claim 1.

25. A heavy vehicle comprising a system for control of driveline geometry of the vehicle, wherein a propeller shaft is suspended in a center bearing unit the position of which can be adjusted, and wherein the adjustment is determined by a method according to claim 15.

26. A method according to claim 15, wherein the method runs automatically.
